(19) United States
(12) Patent Application Publication
(10) Pub. No.: US 2015/0138059 A1
(43) Pub. Date: May 21, 2015

(54) PRIVATE AND NON-PRIVATE DISPLAY MODES

(71) Applicant: Microsoft Corporation, Redmond, WA (US)

(72) Inventors: Timothy Large, Bellevue, WA (US); Steven Bathiche, Kirkland, WA (US)

(73) Assignee: Microsoft Corporation, Redmond, WA (US)

(21) Appl. No.: 14/084,526

(22) Filed: Nov. 19, 2013

(51) Int. Cl. G06F 21/60; G09G 3/36; G09G 3/34

(52) U.S. Cl. CPC G06F 21/60; G09G 3/3406; G09G 3/36; G09G 2358/00
USPC 345/102

(57) ABSTRACT

Embodiments are disclosed that relate to operating a display illuminated by a backlight system configured to selectively emit light having two or more angular intensity profiles. For example, one disclosed embodiment provides a method comprising illuminating the display with light having a first angular intensity profile, while illuminating the display with light having the first angular intensity profile, outputting an image, after outputting the image, illuminating the display with light having a second angular intensity profile different than the first angular intensity profile, and while illuminating the display with light having the second angular intensity profile, outputting an inverse image of the image.

### BACKGROUND

In settings in which confidential or sensitive visual content is presented on a display device, a user may take measures to obtain privacy and ensure that the visual content is not intelligible to other viewers. For example, a privacy screen may be overlaid on the display to reduce the field of view of the display.

### SUMMARY

Embodiments are disclosed that relate to operating a display in private and non-private modes via a backlight system configured to selectively emit light having two or more angular intensity profiles. For example, one disclosed embodiment provides a method comprising illuminating the display with light having a first angular intensity profile, and while illuminating the display with light having the first angular intensity profile, outputting an image. The method further comprises, after outputting the image, illuminating the display with light having a second angular intensity profile different than the first angular intensity profile, and while illuminating the display with light having the second angular intensity profile, outputting an inverse image of the image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows aspects of an example environment in which visual content presented by a display may be privately viewed.

FIG. 2 schematically shows a side view of an embodiment of a backlight system and a modulating display panel.

FIGS. 3A-B schematically shows a first example of a backlight system configured to output light in wide angle and narrow angle modes.

FIGS. 4A-C illustrate another embodiment of a backlight system configured to output light in wide angle and narrow angle modes.

FIGS. 5A-5D illustrate example angular intensity profiles of wide and narrow angle backlighting modes in accordance with embodiments of this disclosure, and illustrates a contrast between an image and inverse image displayed respectively via the narrow angle mode and wide angle mode.

FIG. 6 shows a flow diagram illustrating an embodiment of a method of operating a display device.

FIG. 7 shows a block diagram of an embodiment of a computing device.

### DETAILED DESCRIPTION

As described above, a user may take various actions to ensure that confidential or sensitive visual content presented by a display device is not perceivable or intelligible by other viewers, such as by using a privacy screen. However, a privacy screen may affect an appearance of a displayed image and also of a device displaying the image. Further, a privacy screen may be cumbersome to selectively remove and reattach when switching between private and non-private uses.

To allow for more rapid switching between non-private and private viewing modes, a display device may include a backlight that emits light having different intensity profiles, such that backlighting with a narrow angular band may be used for private viewing while backlighting with a wider angular band may be used for shared viewing. However, in the private mode, it is possible that some amount of light may still be visible outside of the band (e.g. due to imperfections in components, polarization recycling, etc.), which may allow content to be visible, even if at a low intensity, by people sitting nearby.

Accordingly, embodiments are disclosed herein that relate to the display of private images by displaying an image and an inverse image in a time multiplexed manner at intensities selected to produce a combined image viewable from within a first range of angles and not viewable in a second range of angles. These embodiments are described in more detail below.

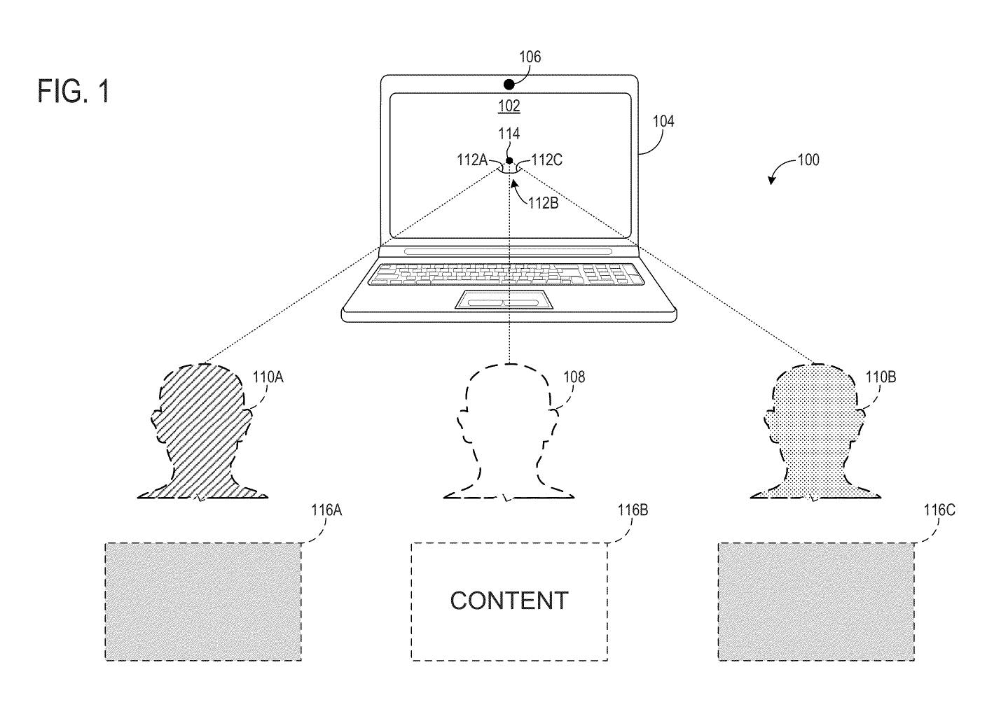

FIG. 1 schematically shows aspects of an example environment 100 in which visual content (e.g., images, video, etc.) presented by a display 102 may be privately viewed. Environment 100 may correspond to many possible settings, including but not limited to an airplane cabin, a library, a café, etc. In the depicted example, display 102 is housed within, and receives visual content from, a computing device in the form of a laptop computer. In other embodiments, the display may be housed in other enclosures (e.g., desktop computing device, smartphone, tablet), or provided separately but operatively coupled to a suitable visual content source.

Display 102 may be driven at a relatively high refresh rate (e.g., 120 Hz) and in some embodiments may switch among two or more refresh rates (e.g., 60 Hz, 120 Hz, etc.) depending on a mode in which it is operated. As such, display 102 may comprise a suitable high-speed display technology, such as a twisted-nematic liquid crystal display (LCD), a vertical alignment display, or a polymer-stabilized vertical alignment display, for example.

Computing device 104 may include a sensor device 106 configured to obtain tracking data (e.g. visible and/or infrared two- and/or three-dimensional image data) to detect, and potentially track a location of, a user 108 operating the computing device. Sensor device 106 also may allow detection of other persons in the use environment, such as persons 110A and 110B, to determine the presence of such persons. Further, tracking data captured by sensor device 106 may be used to track the position (e.g. location and/or orientation) of the head and/or eyes of user 108, and in some embodiments the positions of the heads and/or eyes of persons 110A and 110B. As described in further detail below, head and/or eye tracking may be used to dynamically adjust the output of display 102 in real-time. In other embodiments, such a sensor device may be omitted.

Display 102 may be operated in what is referred to herein as a private viewing mode in which displayed content is easily viewable by user 108 but not discernable by persons 110A and 110C. In the depicted example, the visual content output by display 102 comprises an image represented by the generic term CONTENT which is fully legible and perceptible by user 108 from viewing angle 112B, whose perception of the visual content is schematically represented by window 116B. Conversely, persons 110A and 110B perceive visual content which is approximately uniform, grey, and appears to lack any perceptible text. The perception of visual content by persons 110A and 110C is schematically illustrated by respective windows 116A and 116C.

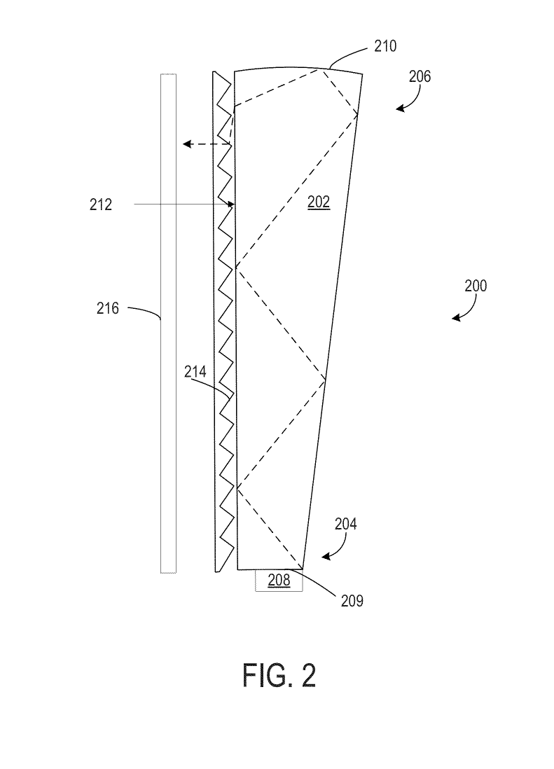

FIG. 2 shows a side view of an embodiment of a backlight system 200 that may be used to illuminate display 102 in FIG. 1. Backlight system 200 comprises a wedge-shaped light guide 202 having a thin end 204 and a thick end 206. Thin end 204 includes a light input interface 209 configured to receive light injected by a plurality of light sources 208, which may include light-emitting diodes or other suitable light sources. Thick end 206 comprises a reflector 210 configured to change the angle of internally reflected light from light sources 208 and to direct the light toward a light exit interface 212, such that the light exits the light exit interface 212 at or above a critical angle of internal reflection. It will be understood that various dimensions of the light guide 202 and the depicted light path may be exaggerated for the purpose of illustration.

Reflector 210 may comprise any suitable geometry, including but not limited to toroidal, spherical, and cylindrical geometries. In some embodiments reflector 210 may be a metalized polyester sheet, prismatic reflector, or multilayer dielectric coated sheet, for example, and in some examples may include one or more facets (not shown). Further, a turning structure 214 may be used to redirect light through a display panel 216.

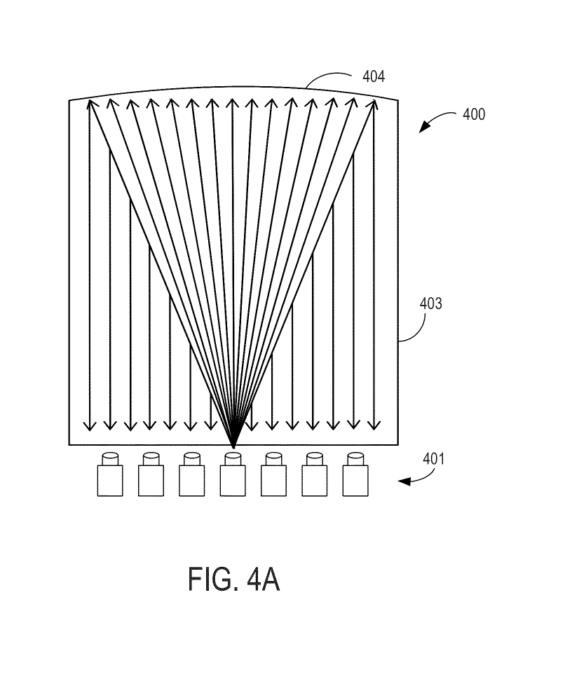

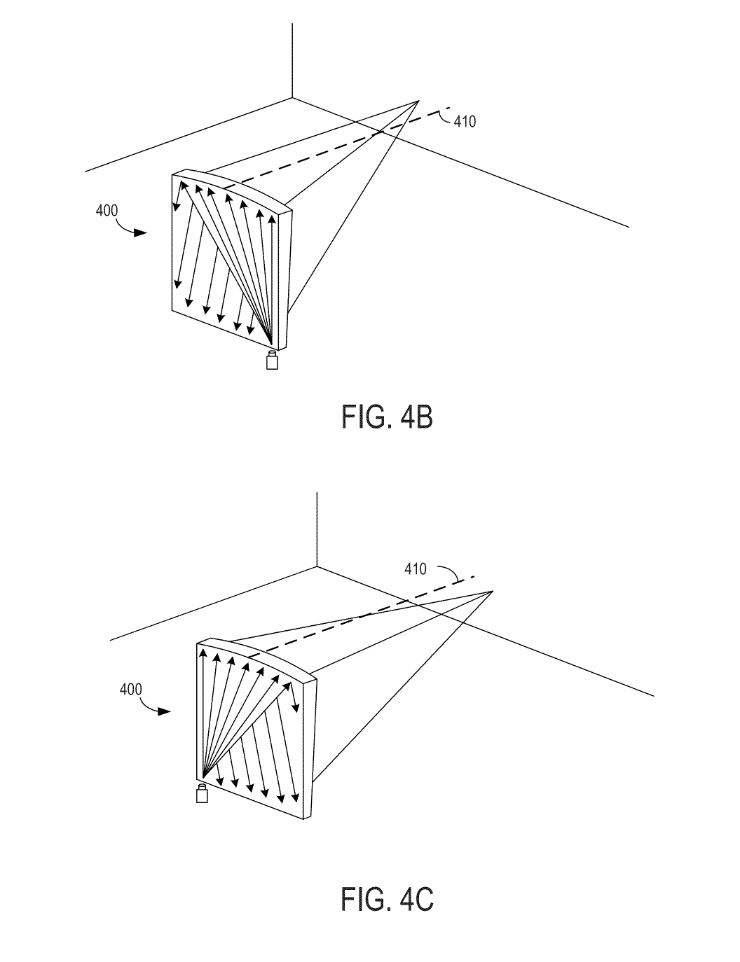

In some embodiments, as described below with reference to FIGS. 4A-4C, reflector 210 may be configured to collimate light from light sources 208, such that collimated light exits light exit interface 212. This may allow information to be displayed in the private viewing mode such that it is easily viewable within a relatively narrower range of viewing angles (e.g., within 5-10° of normal 114 in FIG. 1). Further, varying the location of light injection along a length of light input interface 209 (referring to a direction normal to the plane of the page in FIG. 2) may allow the direction in which the private mode image is output to dynamically adapt to the user's viewing angle as based upon tracking data collected by sensor device 106.

It will be appreciated that the apparent and relative sizes of the components in backlight system 200, as well as the number of light sources 208, are shown for the purpose of illustration and are not intended to be limiting. Further, other approaches may be employed to facilitate private and non-private viewing modes. As other non-limiting examples, a dual light guide comprising two light guide sections may be used to switch between private and non-private modes, or a single monolithic light guide may be used in combination with a switchable diffuser such as a polymer disperse liquid crystal (PDLC). Moreover, backlight system 200 may be augmented with additional components such as a cladding layer included to achieve desired critical angles of internal reflection.

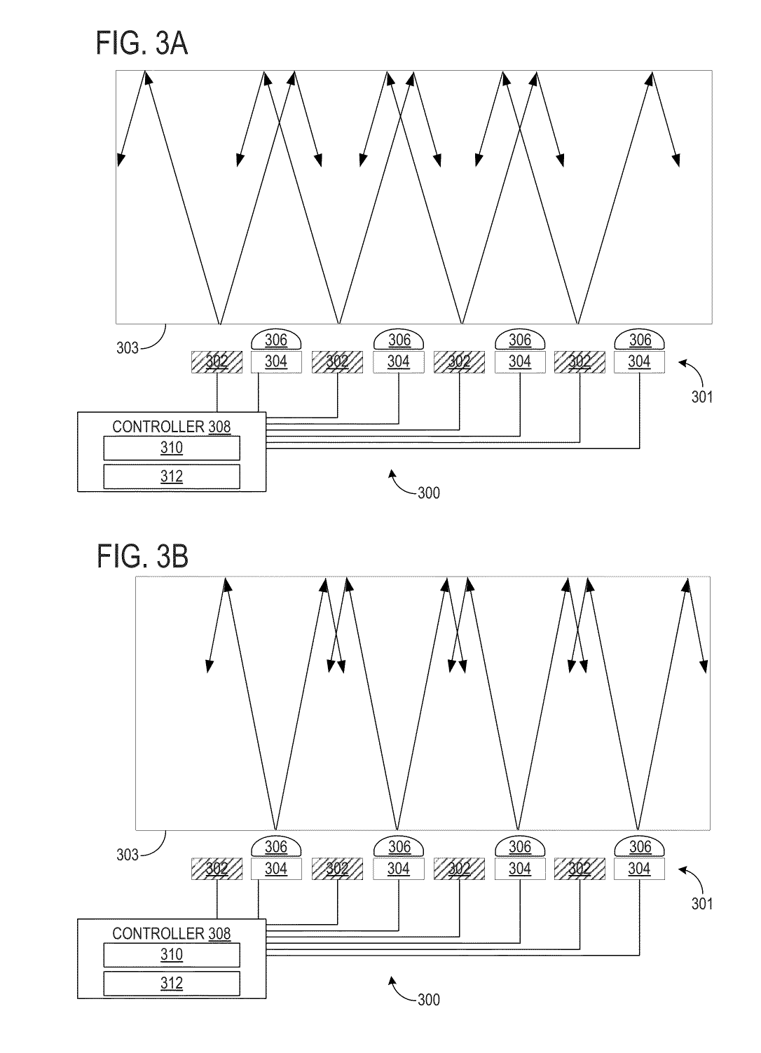

FIGS. 3A and 3B schematically show top views of one example of a suitable backlight system 300 for enabling a private mode display. Backlight system 300 includes a plurality of light sources 301. The plurality of light sources 301 includes 301 includes a first subset of light sources 302 (shaded in the figure) configured to inject light having a relatively wide angular intensity profile into an optical wedge 303, and also a second subset of light sources 304 configured to inject light having a relatively narrow angular intensity profile. To achieve a narrow angular intensity profile, each light source in the second subset of light sources 304 includes a concentrator 306 configured to concentrate light from its adjacent light source to which it is optically coupled. Each concentrator 306 may take the form, for example, of a cylindrical lens that act as a horizontal collimator concentrating light in a direction along a thin end of optical wedge 303, for example. When used with an optical wedge 303 comprising a cylindrical end reflector, the first subset of light sources 302 may be illuminated to provide for a non-private mode, and the second set of light sources 304 may be illuminated to provide for a private mode.

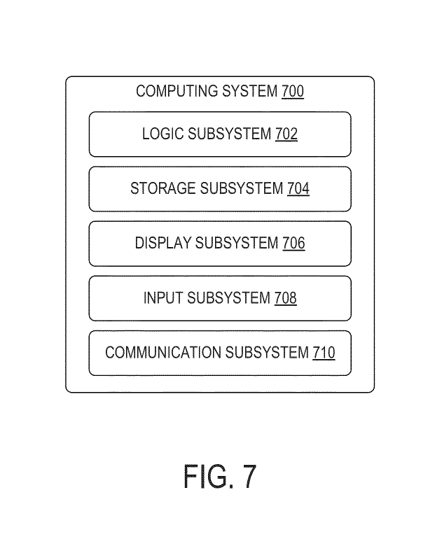

As shown in FIGS. 3A and 3B, the plurality of light sources 301 are operatively coupled to a controller 308 comprising a logic subsystem 310 and a storage subsystem 312. Storage subsystem 312 may include instructions executable by logic subsystem 310 to control light sources 301, drive selection of the non-private and private viewing modes, and in some embodiments adapt backlight illumination to user and/or other person tracking data. Logic and storage subsystems 310 and 312 may be included in computing device 104 in FIG. 1, for example. Examples of suitable logic and storage subsystems are described below with reference to FIG. 7. While the embodiment of FIG. 3 shows two different subsets of light sources, other embodiments may utilize three or more.

FIGS. 4A-C schematically another example of a suitable backlight system 400 for enabling a private mode display. As shown in FIG. 4A, backlight system 400 includes a plurality of light sources 401 configured to inject light into an optical wedge 403 having a toroidal (or other suitably-shaped) end reflector 404. The optical wedge 403 of FIG. 4 is collimating, such that a direction of light emitted by the wedge may be changed by varying a location at which light is injected into the optical wedge via selectively illuminating different subsets of light sources 401. FIGS. 4B and 4C illustrate light being directed in two example directions compared to a display normal 410 by different lights of light sources at different locations along the thin end of the optical wedge 403. In the example of FIG. 4, an image may be displayed in a non-private mode by illuminating a plurality of lights of light sources 401, such that light is emitted in different directions, and in a private mode by illuminating one light source, or otherwise illuminating a smaller set of light sources that are located relatively close together, so that the emitted light is more directional in nature.

With these or other private backlight systems, an image displayed in a narrow angle mode may still be visible to a viewer sitting next to a user of a computing device incorporating the backlight system due various factors. A luminance of 0.3% or less of the on-axis luminance may be sufficient to render an image unviewable. However, due to the factors discussed above, the actual off-axis luminance at 30-40 degrees off-axis may be on the order of 3-5%.

Thus, as mentioned above, to make the image less visible at such angles, an image and its inverse image may be displayed in an alternating or other time-multiplexed fashion at a sufficient frequency to be averaged by the eye, and wide and narrow backlight modes may be operated in a synchronized fashion at power levels selected to cause the image and inverse image to effectively cancel out at desired angular ranges. Power levels of each of the wide angle and narrow angle modes may be controlled to achieve a desired on-axis luminance and also to achieve a region in which the image and inverse image cancel each other sufficiently as to be difficult to view. At the angle where the luminance of the wide angle mode is the same as the luminance of the narrow angle mode, the image and the inverse image are equally present, so the user sees grey. However, the image also may be imperceptible at a range of angles around this point, as an image contrast of below approximately 3:1 for monochrome text and approximately 7:1 for color may be very difficult to read, and contrasts in these ranges may extend a wide range on either side of the point of zero contrast.

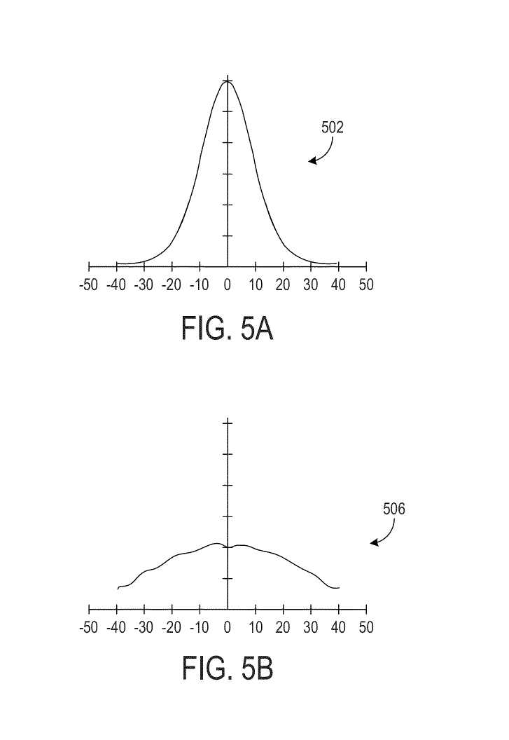

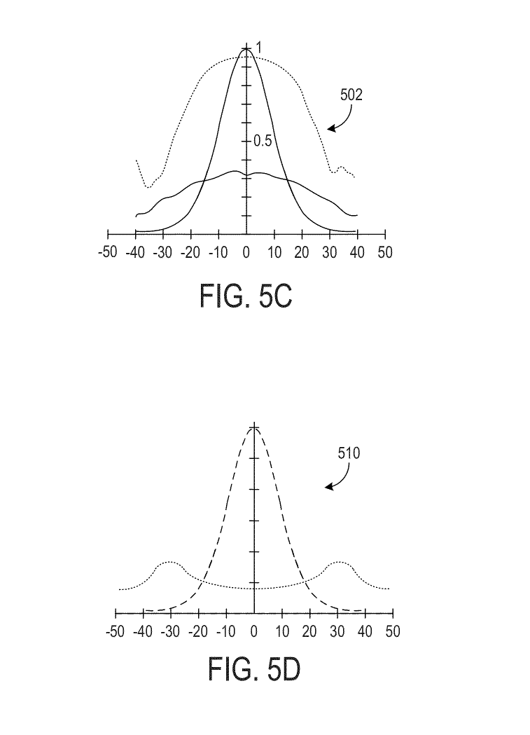

FIGS. 5A and 5B respectively illustrate example angular intensity distributions for the narrow and wide backlight modes, and FIG. 5C shows the distributions of FIGS. 5A and 5B along with a graphical representation of the Michelson visibility for an image and inverse image respectively displayed via the narrow and wide modes. The Michelson visibility is defined as ((L1−L2)/(L1+L2)), where L1 & L2 represent the luminance of the image and anti-image displayed in the narrow and wide angle modes respectively. A contrast ratio of 3:1 corresponds to a Michealson visibility of 0.5. Thus, in order to render an image difficult to read at an angular range of 30-40 degrees off-axis, the wide and narrow luminances in the 30-40 degree range may be balanced to achieve less than 0.5 Michelson visibility. As one non-limiting example, and referring to the embodiment of FIG. 4A, on-axis LEDs may be driven at full power for the first half of a 60 Hz frame period, and the off-axis LEDs may be driven at 1/15th of full power for the second half of 60 Hz frame. The eye response averages the scene to achieve the desired contrast within the target angle range. Referring again to FIG. 5C, it can be seen that the contrast has a value close to 1 over a range of approximately +/−20 degrees, but then drops rapidly to about ⅓ in the range of 30-40 degrees off axis, which may make the image very difficult to view.

The effect of displaying the image and inverse image in a time multiplexed manner may result in the loss of some dynamic range at the intended viewing angle (e.g. normal to the screen, or at another angle where user tracking and dynamic adjustment of the image display angle are employed) due to the luminosity of the inverse image at the optical axis, represented by the vertical axis in FIG. 5C. Thus, to prevent such loss of contrast, a wide angle mode having a bimodal distribution may be used to reduce the effect of the inverse image at the intended viewing angle. FIG. 5D illustrates an example of such a distribution in combination with the narrow mode profile of FIG. 5A, and illustrates the reduced effect of the wide angle mode backlight on the narrow angle image contrast at the normal viewing angle. Such a bimodal distribution may be achieved, for example, via the use of concentrators with the light sources for an optical wedge, or in any other suitable manner.

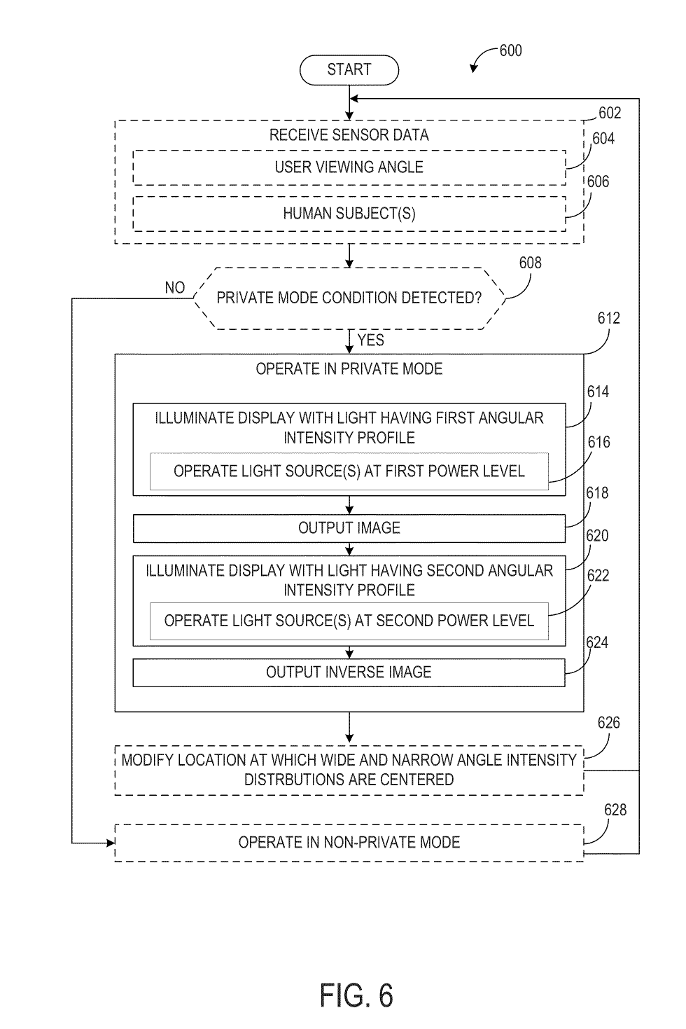

FIG. 6 is a flow diagram illustrating an embodiment of a method 600 for operating a display in a private viewing mode. Method 600 includes, at 602, optionally receiving tracking data, for example via a sensor device. The tracking data may be used to determine a user's viewing angle, as indicated at 604, and/or may be used to locate other persons than the user in the use environment, as indicated at 606.

Method 600 further includes, at 608, determining whether a private mode condition exists. As one example, a private mode condition may exist where the tracking data received at 602 indicates the presence of people other than the user in locations at which the display may potentially be viewable. As another example, a private mode condition may be set via a user input, and may exist until the user selects to operate in the non-private mode.

If no private mode condition is detected, then method 600 comprises, at 628, operating in a non-private mode in which a wide angle backlight is utilized and the inverse image is not output. Method 600 then returns to 602 to analyze additional sensor data. On the other hand, if a private mode condition exists (e.g. the tracking data indicates the presence of other persons, receipt of a user input to operate in a private mode, etc.), then method 600 comprises, at 612, operating in a private mode. It will be understood that any suitable conditions may be applied when determining whether to operate in a private or non-private mode, and that priority levels may be assigned to private and non-private mode conditions. For example, if a user is outside of a range of angles at which a private mode image is viewable as determined from sensor data, the non-private mode may be used, even if other private mode conditions (e.g. other persons are present), as contextual information determined from the tracking data may indicate that the user has turned the display to make it more visible to another person.

Operating in the private viewing mode may include illuminating the display with light having a first angular intensity profile at 614. The first angular intensity profile may comprise a relatively narrow angular intensity distribution suited for private viewing (e.g., as shown in FIG. 5A). Display illumination with the first angular intensity profile may further comprise, at 616, operating the light sources used for the narrow angle mode at a first power level (e.g. a relatively higher power level), and, at 618, outputting an image.

Operating in the private mode further comprises, at 620, illuminating the display with light having a second angular intensity profile. The second angular intensity profile may comprise a relatively wider angular intensity distribution (e.g., as shown in FIGS. 5B and 5D). Further, while illuminating the display with light having the second angular profile, method 600 comprises, at 622, operating the backlight at a second power level, which may be less than the first power level. Further, method 600 comprises, at 624, outputting an inverse image of the image output at 618. The angular intensity profiles and backlight power levels for the wide and narrow angle modes may be chosen such that the image has a greater intensity than the inverse image at a first viewing angle (e.g., between 0 to 10 degrees from the display normal), and such that the image and inverse image have sufficiently similar intensities at a second viewing angle (e.g., between 30 and 40 degrees from the display normal) for the human eye averaging the image and inverse image not to perceive the image. It will be understood that the image and inverse image may be displayed at a suitable frame rate for the human eye to perform such averaging. Private mode operation may continue until a private mode condition is no longer detected.

In embodiments in which a user's position is tracked, method 600 may optionally comprise, while operating in the private mode, modifying a location at which the wide and narrow angle intensity distribution are centered, as indicated at 626, such that the distributions remain centered at the user's viewing location. This may help to preserve image contrast as the user's head moves relative to the display.

In this manner, a user viewing the image from an angle sufficiently close to the optical axis (e.g. display normal, or otherwise a center of the wide and narrow angle distributions) may easily perceive the image, yet others viewing the image from angles farther from the optical axis may not be able to discern the image. Thus, viewing privacy may be achieved without the use of privacy screens or other conventional methods.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 7 schematically shows a non-limiting embodiment of a computing system 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices, including but not limited to those described above.

Computing system 700 includes a logic subsystem 702 and a storage subsystem 704. Computing system 700 further includes a display subsystem 706, and may include an input subsystem 708, communication subsystem 710, and/or other components not shown in FIG. 7.

Logic subsystem 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage subsystem 704 includes one or more physical devices configured to hold instructions executable by the logic machine to implement the methods and processes described herein. When such methods and processes are implemented, the state of storage subsystem 704 may be transformed—e.g., to hold different data.

Storage subsystem 704 may include removable and/or built-in devices. Storage subsystem 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 704 may include volatile, nonvolatile, dynamic, static, read/write, read-only, random-access, sequential-access, location-addressable, file-addressable, and/or content-addressable devices.

It will be appreciated that storage subsystem 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 702 and storage subsystem 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

Display subsystem 706 may be used to present a visual representation of data held by storage subsystem 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic subsystem 702 and/or storage subsystem 704 in a shared enclosure, or such display devices may be peripheral display devices.

When included, input subsystem 708 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 700 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a computing system, a method for operating a display illuminated by a backlight system configured to selectively emit light having two or more different angular intensity profiles, the method comprising:
illuminating the display with light having a first angular intensity profile;
while illuminating the display with light having the first angular intensity profile, outputting an image;
after outputting the image, illuminating the display with light having a second angular intensity profile different than the first angular intensity profile; and
while illuminating the display with light having the second angular intensity profile, outputting an inverse image of the image.

2. The method of claim 1, wherein the display is illuminated with light having the first angular intensity profile and light having the second angular intensity profile respectively at a first power level and a second power level such that the image has a greater intensity than the inverse image at a first viewing angle, and such that the image and inverse image have a same intensity at a second viewing angle.

3. The method of claim 2, wherein the second viewing angle is 30 to 40 degrees from a normal of the display, and wherein the first viewing angle is within a range of 0 to 10 degrees from the normal of the display.

4. The method of claim 1, further comprising:
receiving tracking data indicating a user viewing angle; and
modifying an angular location of one or more of the first and second angular intensity profiles relative to a normal of the display screen.

5. The method of claim 1, wherein the display comprises one or more of a twisted-nematic liquid crystal display (LCD), a vertical alignment display, and a polymer-stabilized vertical alignment display.

6. The method of claim 1, wherein the computing system is configured to switch between a private mode in which the inverse image is output, and a non-private mode in which the inverse image is not output.

7. The method of claim 6, further comprising:
operating in the non-private mode;
receiving tracking data indicating a presence of one or more persons in a field of view of the display; and
if the tracking data indicates that a human subject other than a user is present, operating in the private mode.

8. The method of claim 6, further comprising:
receiving tracking data indicating a user viewing angle; and
operating in the non-private mode based upon the user viewing angle.

9. The method of claim 1, wherein the second angular intensity profile comprises a bimodal intensity distribution.

10. A computing system, comprising:
a display;
a backlight system configured to selectively illuminate the display with light having two or more different angular intensity profiles;
a logic subsystem operatively coupled to the display and the backlight system; and
a storage subsystem comprising instructions executable by the logic subsystem to:
illuminate the display via the backlight with light having a first angular intensity profile;
while illuminating the display with light having the first angular intensity profile, output an image on the display;
after outputting the image, illuminate the display via the backlight with light having a second angular intensity profile different than the first angular intensity profile; and
while illuminating the display with light having the second angular intensity profile, output an inverse image of the first image on the display.

11. The computing system of claim 10, wherein the display is illuminated with light having the first angular intensity profile and light having the second angular intensity profile respectively at a first power level and a second power level such that the image has a greater intensity than the inverse image at a first viewing angle, and such that the image and inverse image have a same intensity at a second viewing angle.

12. The computing system of claim 10, wherein the instructions are further executable by the logic subsystem to:
receive tracking data indicating a user viewing angle; and
change an angular location of one or more of the first and second angular intensity profiles relative to a normal of the display screen.

13. The computing system of claim 10, wherein the display comprises one or more of a twisted-nematic liquid crystal display (LCD), a vertical alignment display, and a polymer-stabilized vertical alignment display.

14. The computing system of claim 10, wherein the computing system is configured to switch between a private mode in which the inverse image is output, and a non-private mode in which the inverse image is not output.

15. The computing system of claim 14, wherein the instructions are further executable by the logic subsystem to:
operate in the non-private mode;
receive tracking data indicating a presence of one or more persons in a field of view of the display; and
if the tracking data indicates that a person other than a user is present, then operate in the private mode.

16. The computing system of claim 14, wherein the instructions are further executable by the logic subsystem to:
receive tracking data indicating a user viewing angle; and
operate in the non-private mode based upon the user viewing angle.

17. The computing system of claim 10, wherein the second angular intensity profile comprises a bimodal distribution.

18. A laptop computing system, comprising:
a display;
a backlight system configured to selectively illuminate the display with light having two or more different angular intensity profiles;
a logic subsystem operatively coupled to the display and the backlight; and
a storage subsystem holding instructions executable by the logic subsystem to
illuminate the display via the backlight with light having a first angular intensity profile;
while illuminating the display with light having the first angular intensity profile, output an image on the display;
after outputting the image, illuminate the display via the backlight with light having a second angular intensity profile different than the first angular intensity profile; and
while illuminating the display with light having the second angular intensity profile, output an inverse image of the image on the display.

19. The laptop computing system of claim 18, wherein the display is illuminated with light having the first angular intensity profile and light having the second angular intensity profile respectively at a first power level and a second power level such that the image has a greater intensity than the inverse image at a first viewing angle, and such that the image and inverse image have an intensity at a second viewing angle.

20. The laptop computing system of claim 18, wherein the laptop computing system is configured to switch between a private mode in which the inverse image is output, and a non-private mode in which the inverse image is not output.
